(19) United States
(12) Patent Application Publication
(10) Pub. No.: US 2019/0019438 A1
(43) Pub. Date: Jan. 17, 2019

(54) FLAG POLE ASSEMBLY

(71) Applicant: Kerry Lee, Birmingham, AL (US)

(72) Inventor: Kerry Lee, Birmingham, AL (US)

(21) Appl. No.: 15/646,702

(22) Filed: Jul. 11, 2017

(51) Int. Cl. G09F 17/00

(52) U.S. Cl. CPC G09F 17/00; G09F 2017/0075; G09F 2017/0066; G09F 2017/005

(57) ABSTRACT

A flagpole assembly that includes: a pole, where the pole includes a top and mounting base; a plurality of openings along the left of the pole; at least one mounting hole within the mounting base; at least one removable flag, where the said flag includes flag inserts adapted for insertion into openings provided on the pole; and an anchor, where the anchor is adapted to receive the mounting base of the pole. The anchor preferably includes at least two suction cups adapted to secure to a surface of a vehicle.

### BACKGROUND OF THE INVENTION

### Field of Invention

The present invention relates to a flagpole assembly for mounting on a motor vehicle.

### Description of Related Art

Vehicle flags are used in various applications for hoisting a flag and mounting it on a moving vehicle. Many times the flags are assembled in a uniform construction and mount to a window or door opening as suggested in U.S. Pat. No. 7,878,139 to Karnes. Karnes discloses an universal automobile flag, which has attachment means for a window and also onto the trunk area of the motor vehicle. Most of the flag mounting assemblies include a pole of some sort that hangs the flag in place. One variation of the traditional flag assembly is shown in U.S. Patent Publication 2015/0090177 to Allen. Allen discloses a flag display system that uses a zipper arrangement around the bracket of the vehicle as shown. Yet another example of a vehicle flag assembly system is shown in U.S. Patent Publication 2015/0310778 to Baker. Baker discloses a flag assembly again that has a mounting mechanism associated with the window opening.

The object of the present invention is to provide a flag pole assembly that provides more flexibility in mounting positions on a vehicle. Also the present invention provides a pole that allows for variable arrangement of flags onto a single pole.

### SUMMARY OF THE INVENTION

The present invention relates to a flagpole assembly that includes: a pole, where the pole includes a top and mounting base; a plurality of openings along the left of the pole; at least one mounting hole within the mounting base; at least one removable flag, where the said flag includes flag inserts adapted for insertion into openings provided on the pole; and an anchor, where the anchor is adapted to receive the mounting base of the pole. The anchor preferably includes at least two suction cups adapted to secure to a surface of a vehicle.

### BRIEF DESCRIPTION OF DRAWINGS

FIG. 1 depicts a flagpole assembly in accordance with the present invention.

FIG. 2 depicts an alternative flagpole assembly with mounting base in accordance with the present invention.

FIG. 3 depicts a flagpole receiver for the flagpole in accordance with the present invention.

### DETAILED DESCRIPTION

The present invention relates to a flagpole assembly designed for mounting on a motor vehicle. The flagpole assembly includes a pole that has a series of openings along the length of the pole. The pole has a mounting base with at least one mounting hole within the mounting base. The mounting base adjoins to an anchor that includes a receiving base to receive the mounting base of the flagpole. The anchor is attached to any surface on the motor vehicle by the use of suction cups placed along the bottom of the anchor. Once in place flags may be mounted on the pole through the openings provided. The pole according to the present invention provides sufficient openings to receive at least two flags along the length of the pole. The flag includes inserts that insert into the openings of the pole. One alternative mounting base is provided for the present invention, which is glued into place and receives the pole through a threaded receiving hole provided on the mounting base. In this particular embodiment, the pole includes a male-threaded base to mount into the receiving hole of the mounting base.

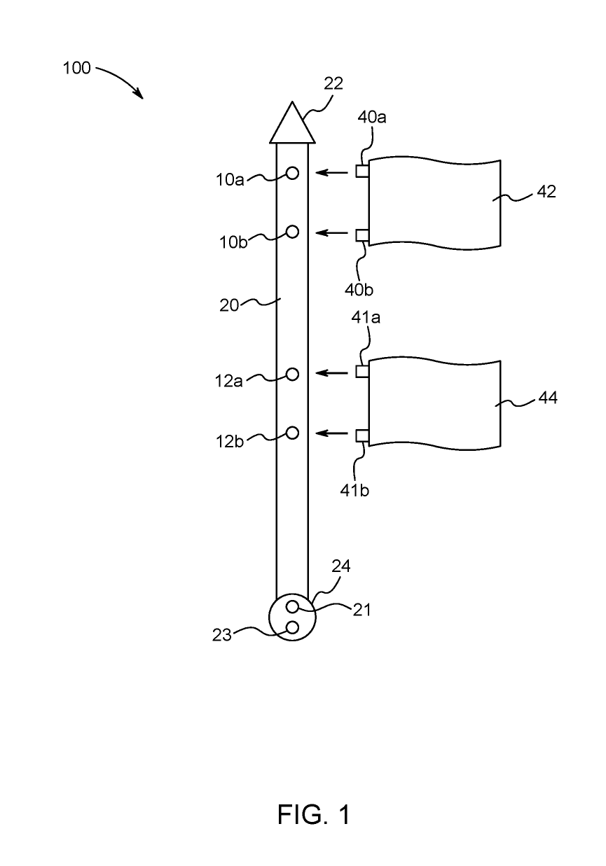

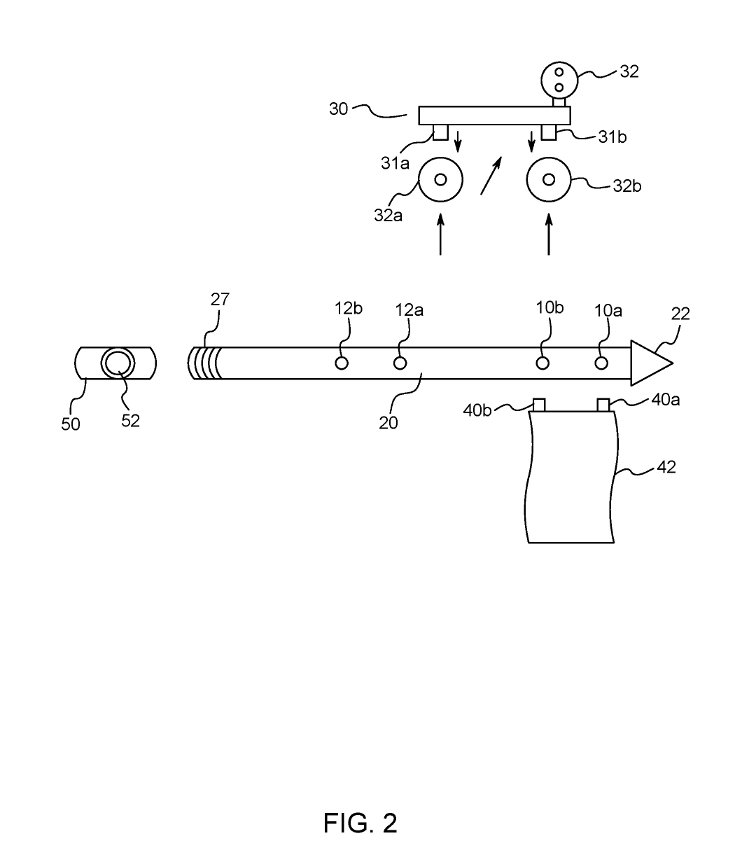

In reference to FIG. 1, a flagpole 20 in accordance with the present invention depicted. The flagpole 20 mounts upon an anchor 30 also shown in FIG. 2. Features of flagpole 20 include a top 22 and mounting base 24. Along the length of the pole 20 are a series of openings 10a, 10b 12a, 12b. These openings 10a, 10b 12a, 12b receive flags 42, 44 as shown in FIG. 1. Flags 42, 44 each include inserts that insert into the openings provided on the flagpole 20. Inserts 40a, 40b shown on Flag 42 and further Inserts 41a, 41b shown on Flag 44. The mounting base 24 includes mounting holes 21, 23 and engage into the receiving base 34 on anchor 30. The receiving base 34 includes posts 31a, 31b that engage the mounting holes 21, 23 to secure the pole 20 into place on the anchor 30. The anchor 30 also includes flagpole receiver 32 which provides support for the flagpole 20 once it is in place on the anchor.

The anchor 30 may be placed upon any surface of the vehicle by the use of suction cups 32a, 32b shown in FIG. 1. These are suction cups 32a, 32b are mounted onto posts 31a, 31b along the bottom surface of anchor 30. Once assembled this flagpole 20 is secured upon a surface of the vehicle and creates a sturdy flexible flagpole. A single flag 42 or flag 44 may be mounted on the pole 20 or dual flags may be mounted on the pole 20.

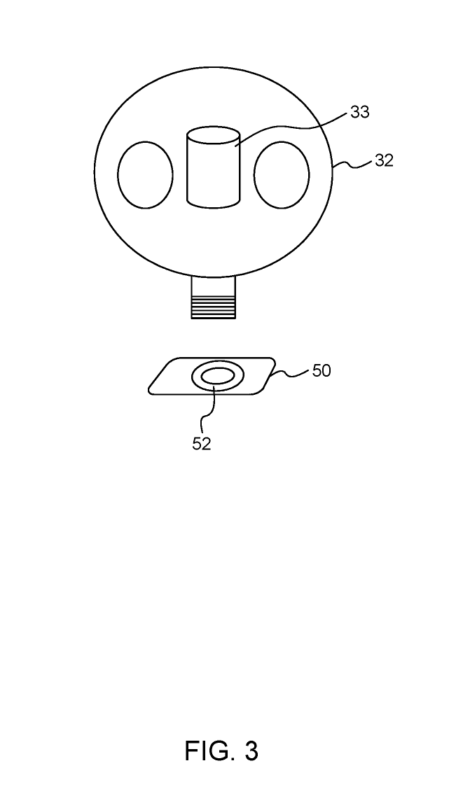

In an alternative environment shown on FIG. 2, flagpole 20 may include a threaded base 27. This threaded base 27 may be placed into a receiving hole 52 of an alternative mounting base 50 shown. This particular base 50 is glued into place along the surface of the vehicle to receive this alternative flagpole 20 shown in FIG. 2. FIG. 3 shows the flagpole receiver 32 including a tub 33. The tub 33 extends through the flagpole receiver 32 to connect with the receiving hole 52.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed:

1. A flagpole assembly comprising:
a pole, where the pole includes a top and mounting base;
a plurality of openings along the left of the pole;
at least one mounting hole within the mounting base;
at least one removable flag, where the said flag includes flag inserts adapted for insertion into openings provided on the pole; and
an anchor, where the anchor is adapted to receive the mounting base of the pole.

2. The flagpole assembly according to claim 1, where the anchor includes at least two suction cups adapted to secure to a surface of a vehicle.

3. The flagpole assembly according to claim 1, where the anchor includes a threaded female receiver.

4. The flagpole assembly according to claim 3, where the pole includes a male threaded tip adapted to mount into the threaded female receiver.

5. The flagpole assembly according to claim 1, where the plurality of openings include four openings.

6. The flagpole assembly according to claim 1, where each flag includes two inserts.

7. The flagpole assembly according to claim 1, where the anchor include posts to support at least two suction cups.
